(19) United States
(12) Patent Application Publication
(10) Pub. No.: US 2004/0020980 A1
(43) Pub. Date: Feb. 5, 2004

(54) System for scanning, processing, and storing disk

(76) Inventor: Vernon N. Whiteing, Alexandria, VA (US)

Correspondence Address: VERNON N. WHITEING, 413 S VAN DORN ST. T-1, ALEXANDRIA, VA, 22304, US

(21) Appl. No.: 10/209,113

(22) Filed: Jul. 31, 2002

(51) Int. Cl. G06F 17/60; G07C 13/00; G09B 9/00; G09B 19/00

(52) U.S. Cl. 235/51; 434/306; 705/12

(57) ABSTRACT

System for processing data and disk removal and storage therein. The enclosure contains the means for data processing, disk removal, and disk storage. The system works by inserting a disk into the tray and sliding it forward into the enclosure opening. As the tray proceeds forward, it activates the data processing devices beneath it (if not already activated) that record the data. As the tray proceeds further into the enclosure, the disk is removed from the tray and deposited into the internal storage canister to be used for future reference.

### FIELD OF THE INVENTION

Voting Systems

### PRIOR ART

Technologies used in voting can either constrain or encourage voter participation in our democratic, electoral process. The events of the previous Presidential Election demonstrated the need for a new voting system technology. This event inspired me to design and fabricate a voting system that is easy to use, reliable, cost-effective, accurate and flexible.

Punch cards, Lever/Push Button Direct Recording Equipment, Optical Scanners, and Touch Screen DREs are four major types of equipment used for voting. Punch cards are comparatively slow and are more difficult to count. Their reliability is suspect especially when recounts are necessary. Another disadvantage is that they generally cannot be used for mail-in voting.

Lever/Push Button Direct Recording Equipment is another older type of equipment used for voting. Proper maintenance is necessary to ensure accuracy Maintaining and servicing this type of equipment is increasingly difficult every year This equipment cannot be used for mail-in voting.

Optical type Scanners are also used to read ballots These machines work primarily like lottery machines. The voter uses a pen or pencil mark to darken an area of the ballot that corresponds to their candidate choice, and it is then scanned and registered by an optical reader. These systems require near perfect ballot formats.

Touch Screen DREs are more modern, computerized equipment and operate in the same way as ATMs. Voters indicate their choice by touching the screen and their vote is recorded electronically. Disadvantages of this equipment include frequent maintenance, component failure, and they can be confusing with or without instructions as to selections and options. Because the votes are recorded and stored electronically, there is no way to physically recount the votes, beyond a computer printout. There is also no way of verifying the votes were recorded accurately. Election administrators know that close races happen regularly and a means of accurately recounting the votes is essential to ensuring there is trust in the election results.

### OBJECTS AND ADVANTAGES

In contrast to the latter types of voting equipment, the Disk Scanning System (DSS) has been designed and fabricated to be user friendly. Voters of all ages and abilities can use this system to cast and register their vote. Beyond selecting the preferred disk and inserting it into the system (which is similar to CD insertion), there is minimal learning involved in using this system. This system is also useable by the visually challenged because there is instructional Braille on the external surfaces of enclosure. The external enclosure also contains audible and visual enunciators denoting process completion.

Voters want and need a system in which the candidate selection is clearly defined, and one they are confident will accurately register their vote for their selected candidate. A system with a reliable ballot (beyond “punched holes”, “dimpled or flying chads,” or a “complex screen menu”) is needed, one that will produce an accurate and tangible count or recount when necessary. The Disk Scanning System is also cost-effective, easy to maintain, service and store.

Another advantage of the system is it reliability and durability. The disk used with this system is a durable item with a picture, photo, or hologram of the candidates. The disk surface has braille on the edges also. Once the voter has made his disk selection, inserted it into the tray, and slid it forward into the enclosure, underlying data interpreting devices register the voter's selection. Then, as the disk continues forward it is removed from the tray and deposited into a storage canister inside of the enclosure. When the canister is full, it can be removed, stored and replaced with a new one. The advantage of the removable canister with disk is that they can thus be collected and stored elsewhere for future reference. This technique will provide an accurate, physical and tangible means of recounting votes when necessary.

An additional advantage is the instructional Braille on the external surface of enclosure with audible and light enunciators that denotes the process has been completed. These devices will assist people in the booth indicating their vote has been cast.

Another advantage is that the system is also compact, lightweight, and easily transported. An additional advantage of this system is that the disk design allows its use as a stand alone, mail-in ballot.

### BRIEF DESCRIPTION OF THE DRAWINGS

The aforementioned objects and advantages of the present Disc Scanning System as well as additional objects and advantages thereof, will be more fully understood hereinafter as a result of a detailed description of a preferred embodiment when taken in conjunction with the following drawings in which:

FIG. 1 shows a perspective view of the enclosure

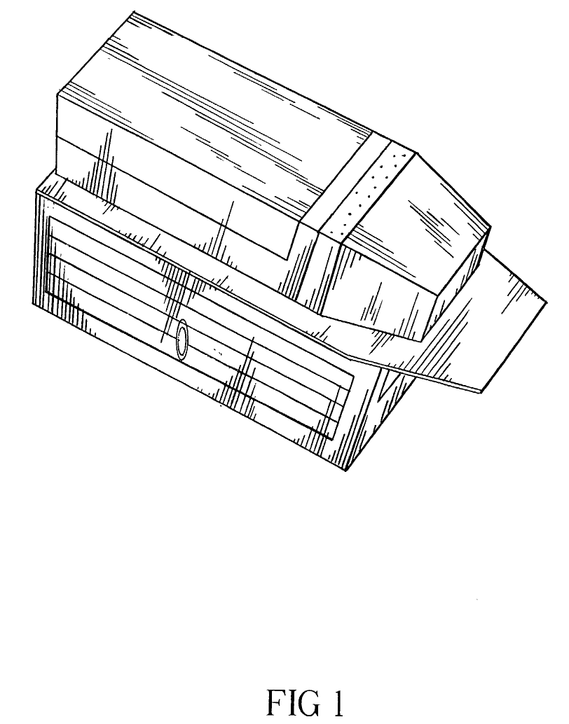

FIG. 2 shows a plan view of enclosure

FIG. 3 shows a right-side view of enclosure

FIG. 4 shows a right side view of enclosure on a support table

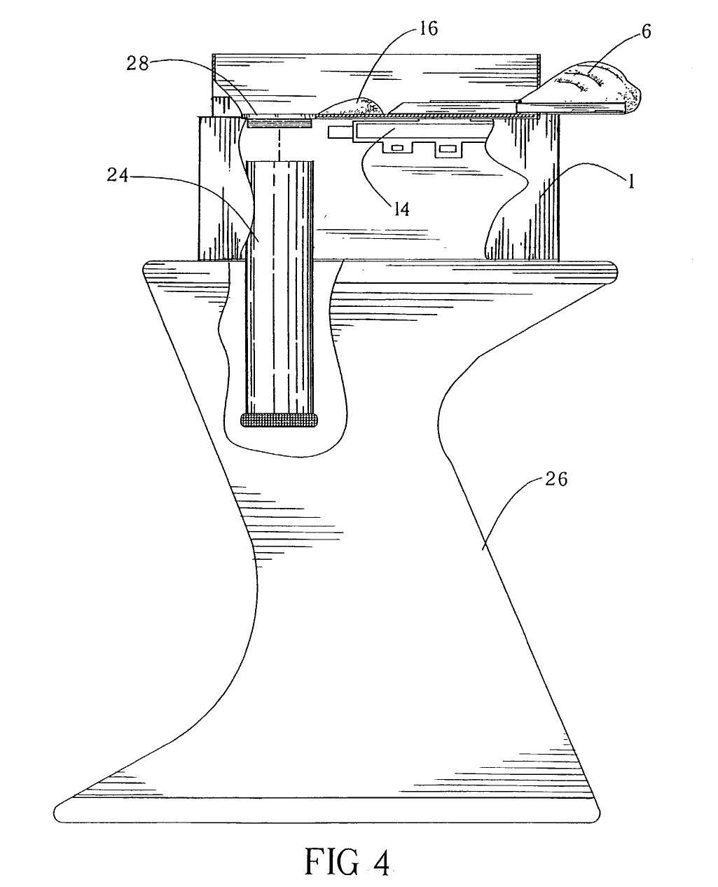

### REFERENCE NUMERALS IN DRAWINGS

1 Enclosure

4 Enclosure Floor

6 Hand-Positioning and Influencing Guide

8 Pivoting Member

10 Disk Shuttle Member

12 Disk

14 Data Interpretation Devices

16 Concentric lobe

18 Congruent Rails

20 Enclosed Raceways

22 Internal Walls

24 Canister

26 Table

28 Coupling

30 Micro Switch

### DETAILED DESCRIPTION OF A PREFERRED EMBODIMENT

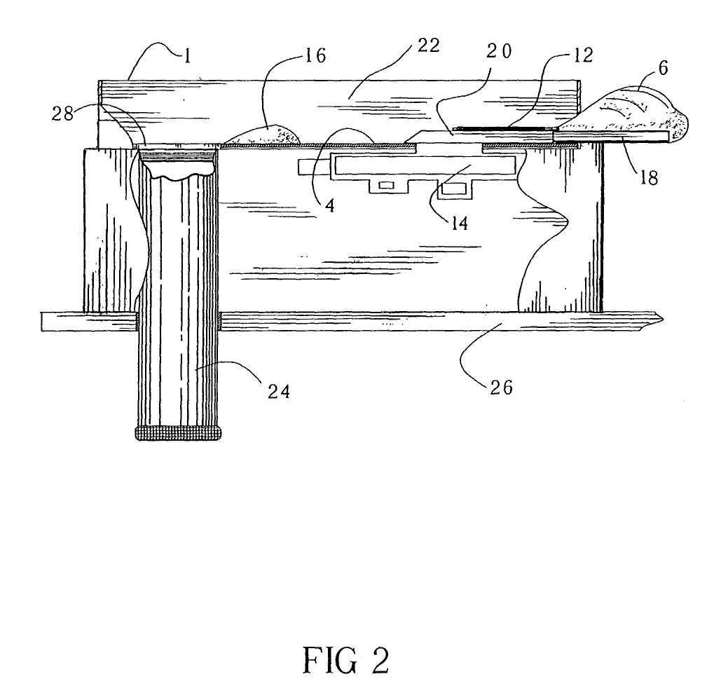

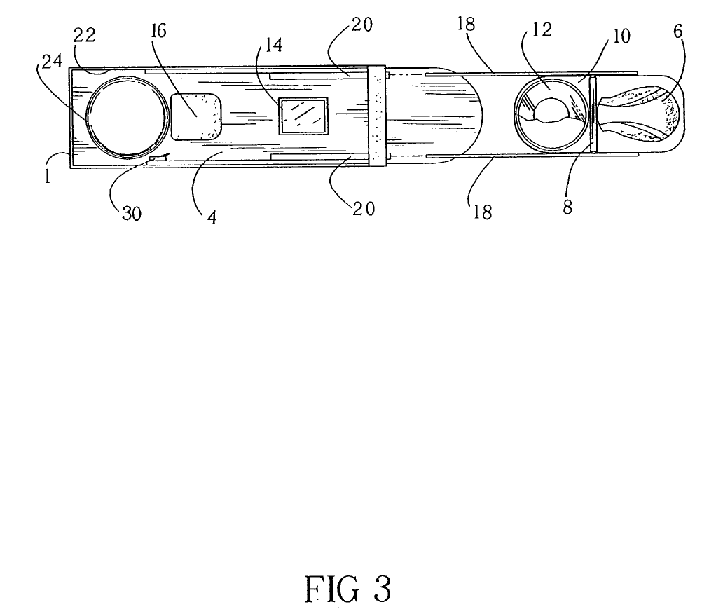

The preferred embodiment comprises an enclosure 1 and a mid-level interior floor 4 (FIG. 2). There is an ergonomic hand-positioning and influencing guide 6 attached by a pivoting member 8 to a disk shuttle member 10 (FIG. 2). This disk shuttle member 10 contains a substantially recessed and void surface therein. The void surface in the disk shuttle member 10 (FIG. 2), exposes a disk 12 to the data interpretation devices 14 and to a concentric lobe 16 for the disk removal function. The guide member 6, pivoting member 8 and disk shuttle member 10 are sandwiched between congruent rails 18 for insertion into the enclosure raceways 20 positioned on each side of the internal walls 22 (FIG. 2) This enables a nutation and slidabilty motion of the guide member 6, pivoting member 8 and disk shuttle member 10. The enclosure has data interpretation devices 14 and an applicable memory means to enhance system objectivity. These are positioned at a level near enclosure floor 4. The internal walls 22 of the enclosure 1 are structured and ribbed along the X-Y-Z axis for stability and rigidity therein. Furthermore, there is an internal and removable canister 24. This canister 24 is of substantial diameter and length, with a low friction coefficient bore and is externally threaded. The canister 24 extends substantially downward from the rear portion of the enclosure floor 4 It further extends beyond the enclosure base and through a precise opening in table 26. The rear upper portion of enclosure floor 4 has an integral flush floor mounted base coupling 28 (FIG. 3). The floor coupling 28 is externally threaded for receiving the internally threaded, open end of canister 24. The opposite end of the canister 24 is closed and has substantial knurling for influencing hand positioning when installing or removing the canister 24. A micro switch 30 is positioned in the enclosure 1 for activating the various enunciators.

### Conclusion, Ramifications, and Scope of Invention

Thus the reader will see that the system provides a cost effective, reliable and durable alternative to the voting systems currently in use. The system is designed to be compact and portable, while remaining cost-effective, durable, reliable, and easy to maintain, service, and store.

While my above description contains much specificity, these should not be construed as limitations on the scope of the invention, but rather as an exemplification of one preferred embodiment thereof. Many other variations are possible. For example, an alternate embodiment would be its use as a security identification system In that embodiment, the disk would be encoded with personal and ID information and would be scanned and processed in the same manner as described above. Fabrication could possibly consist of a single enclosure of the rotational or injection molding type process. Materials used could be of recycled LLDPE, HDPE, or a polyethylene material, or even a composite for the weight benefits. Internally raised waffle type reinforcement ribbing, would enhance the stability of the X-Y-Z axis, of the enclosure. Molded-In threads and-molded-In threaded metal inserts would aid final assembly immensely in either molding process. Furthermore, final fabrication is not limited to any of the above mentioned processes, techniques, or materials.

There are other cost-effective molding, and thermoforming techniques, and methods that could be applied to achieve the same desired results.

Accordingly, the scope of the invention should be determined not by the embodiment (s) illustrated, but by the appended claims and their legal equivalents.

I claim:

1. A data processing and storage system, comprising;
a. A enclosure with means for enabling the slidability and nutation motion therein of a guide with a attached and pivoting shuttle member sandwiched between a means for urging a contiguous and fay engagment through said enclosure means along the longitudinal axis, and said shuttle member has a voided and recessed surface for the dispose and retention of a disk therein, and
b. said enclosure has device for data interpretation of said disk disposed in said shuttle member
c. said enclosure has means for said disk removal from said shuttle member therein, and
d. said enclosure has means for a disk storage therein whereby said guide and said shuttle member with said disk are urged through the opening of said enclosure, proceeds over and across said interpretive device disk is processed and removed from said shuttle member and deposited into said storage means.
